(19) United States
(12) Patent Application Publication
(10) Pub. No.: US 2021/0301587 A1
(43) Pub. Date: Sep. 30, 2021

(54) SWITCHABLE GLASS WINDOW WITH AUTOMATIC CONTROL OF THE TRANSMISSION

(71) Applicants: AGC GLASS EUROPE, Louvain-la-Neuve (BE); AGC INC., Tokyo (JP); AGC GLASS COMPANY NORTH AMERICA, Alpharetta, GA (US); AGC VIDROS DO BRASIL LTDA, Sao Paulo (BR); KINESTRAL TECHNOLOGIES, Hayward, CA (US)

(72) Inventors: Tanguy Timmermans, Bruxelles (BE); Andy McNeal, Hayward, CA (US)

(21) Appl. No.: 17/265,625

(22) PCT Filed: Jul. 25, 2019
(86) PCT No.: PCT/EP2019/070093

§ 371 Date: Feb. 3, 2021

(30) Foreign Application Priority Data
Aug. 3, 2018 (EP) 18187305.0

(51) Int. Cl. E06B 3/67; G02F 1/163; E06B 9/24

(52) U.S. Cl. CPC E06B 3/6722; E06B 2009/2464; E06B 9/24; G02F 1/163

(57) ABSTRACT

The present invention concerns a switchable glass window whose light and energy transmission are altered when voltage is applied comprising, An electrochromic (EC) glazing unit whose light transmission, TL, of light, is altered between a minimum value, TLmin, and a maximum value, TLmax, upon variation of a voltage applied to the electrochromic glazing unit, des A source of electrical power for varying the voltage applied to the electrochromic glazing unit, A sensor (5s) for measuring values of a parameter representative of the irradiance, Is, of the sun on the outer surface of the electrochromic glazing unit, A controller (5c) for controlling the voltage applied to the electrochromic glazing unit, said controller being configured for carrying out the following steps: Dividing a range comprised between a lowest boundary, Is1, and a highest boundary, ls(N+1), of the irradiance, Is, into N intervals, Ri=[Isi, ls(i+1)[. For a value of the irradiance, Is, comprised in an ith interval, Ri=[Isi, ls(i±1)[, of the N intervals, R1 to RN, a voltage yielding a value, TL(Ri), of the light transmission is applied as a function of the value of i which is comprised within the range defined by Equation (1), as follows: Wherein ε is comprised between 0 and 1, Ai=1 when i=1 or N+1, and Ai is comprised between 0.8 and 1.2 for i=2 to N.

$$TL ( Ri ) = Ai \times ( TL min + ɛ ) \times {( \sqrt[N - 1]{\frac{T L max}{T L min + ɛ}} )}^{N - i} - A i \times ɛ \times \frac{i - 1}{N - 1} \qquad ( 1 )$$

### TECHNICAL FIELD

The present invention concerns switchable windows, typically architectural windows, comprising an electrochromic glazing capable of switching between a lightened state and a darkened state over substantially the whole of its area or over a selected sub region of its entire area. In particular, the present invention proposes an automated control of the switching of such glazing from one transmission state to another with minimized transition effects.

### BACKGROUND OF THE INVENTION

As illustrated in FIG. 1(a), when solar radiation hits a glazing, a fraction of the incident light, i0, is reflected (=ir), absorbed by the glazing (=ia), and a fraction, i1/i0, is transmitted (=i1) through the glazing. As shown in FIG. 1(b), the fraction of transmitted light depends on the wavelength of the incident light and on the type of glazing, G1 to G3; some glazing, such as G1, transmit more light than others, such as G3.

In optics, “transmission” or “transmittanced” is the property of a substance to permit the passage of light. The fraction which has not been transmitted is reflected and/or absorbed in the process. The transmitted light is a combination of the wavelengths of the light that was transmitted and not absorbed. For example, if white light is shone through a blue filter, the light transmitted appears blue because the red and green wavelengths are absorbed by the blue filter. The values of the transmission of a glazing used herein are as defined in Eq. 1 to 3 for simple, double and triple glazing of § 5.2 of EN410 (2011), which give an average of the light transmission of the glazing over a range of wavelengths, pondered with various factors. Other norms exist for measuring transmission of a glass, yielding values which are related to, albeit not necessarily equal to the values yielded by EN410 (2011). For example, NFRC 201-2014 is widely used in the US. Any value of TL cited in the present document has been measured according to EN410 (2011) and may be correlated unambiguously to the corresponding value measured with another normalized technique such as NFRC 201-2014.

A switchable window comprises a glass or glazing whose light transmission properties, TL, for a given wavelength range can be altered upon application of a voltage, AU, changing from a high transmission state, TLmax, allowing a highest value of light transmission to a low transmission state, TLmin, allowing a lowest value of light transmission. Referring to FIG. 1(a), the value of transmission can be varied by varying one or more of light absorption, light reflection, and light diffusion. Depending on the type of switchable window, the low transmission state, TLmin, may correspond to a darker, (almost) opaque window (higher absorption), a mirror-like window (higher reflection), or a translucent window (higher diffusion). With these properties, switchable windows attract much attention in the field of architectural windows of relatively large dimensions because they can eliminate the need for curtains and inner or outer shades or shutters.

Examples of electrochromic devices and glazing can be found, e.g., in U.S. Pat. No. 9,658,508, WO2014143410, and WO2014113795. The electrochromic glazing requires a burst of electricity for changing its transmission, TL, but once the change has been completed, no electricity is needed for maintaining the particular shade which has been reached. The voltage, AU, applied to the electrochromic glazing, and thus the level of light transmission, TL, can be controlled manually, e.g., with a remote control. Alternatively, a solar irradiance sensor, herein referred to as a “light sensor” or simply as a “sensor”, can be applied at a strategic point, and a controller varies the voltage applied to the electrochromic glazing in response to a parameter representative of the solar irradiance, Is, so as to vary the tint of the glazing as a function of the weather, sun position, etc.

The solar irradiance, Is [W/m²], is the power per unit area received by an area from the sun in the form of electromagnetic radiation in the wavelength range of the measuring instrument, generally in the range of 350 to 2500 nm, but for applications in the visible light, the range 380 to 780 nm is of particular interest. For example, a parameter representative of solar irradiance is the Direct Normal Irradiance (DNI), which is measured at the surface of the earth at a given location with a surface element perpendicular to the sun.

A problem with electrochromic glazing of large dimensions currently available on the market is that the passage from a first value of transmission to a second value of transmission is necessarily accompanied by a transition phase which has a certain duration. For electrochromic glazing of small dimensions like rear-view mirrors in automotive vehicles the duration of the transition phase is so short that it is barely perceptible. For electrochromic glazing of large dimensions, however, the duration is detectable to the eye. Depending on the model of electrochromic glazing, the transition phase is characterized e.g., by an “iris effect,” or by a “honeycomb” effect. The iris effect refers to non-instantaneous and spatially non-uniform changes of transmission, TL, when applying a voltage to switch between a high transmission state and a low transmission state. The iris effect is the result of the delay for a voltage drop to uniformly extend over the whole area through the transparent conductive coatings providing electrical contact to one side or both sides of the device. When applying a higher (or lower) voltage to an electrochromic glazing, the potential is highest (or lowest) close to the edges of the glazing and lowers (or raises) towards the centre of the glazing. This transient difference in potential between the edges and the centre of a large structure results in variations of the corresponding light transmission over the area of the glazing. With time, light transmission levels, TL, become uniform over the whole area of a glazing.

The honeycomb effect is observed in certain models of electrochromic glazing developed for solving the problem of the iris effect which, however, introduce the appearance of a honeycomb grid on the surface of the glazing during a transition phase. New developments in the field of electrochromic glazing tend to reduce the duration of the transition phase to lower values, but to date, not sufficiently for not disturbing in windows of large dimensions, like architectural windows.

The duration of the transition phase is a major hurdle to automation of the tint control (=light transmission, TL) of a glazing as a function of the values of the solar irradiation, Is, because an electrochromic glazing of large dimensions responding continuously to variations of the solar irradiation, Is, would be quasi-continuously changing values of the transmission, resulting in remaining constantly in a transition phase between two changing phases.

A second major hurdle to an automatic control of the level of transmission of a glazing is that, the value of TL automatically attributed to a given value of the intensity of the irradiation, must satisfy a perception of comfort of the user, which seems prima facie to be a subjective condition.

It can be seen from the foregoing review that there remain many problems to be solved to fully automate the control of the transmission of an electrochromic glazing of large dimensions. The present invention proposes an automated tint control of an electrochromic glazing of large dimensions, which reduces the power consumption, reduces the occurrences of transition phases, and which correlates the values of the transmission with both solar irradiation and human perception of comfort to light variations.

### SUMMARY OF THE INVENTION

The appended independent claims define the present invention. The dependent claims define preferred embodiments. In particular, the present invention concerns a switchable glass window whose light and energy transmission are altered when voltage is applied. For example, the variation of a voltage applied to the electrochromic glazing unit can alter the light and energy transmission, TL, by varying the light absorption and/or the light reflection. The switchable glass window of the present invention comprises,
(a) An electrochromic (EC) glazing unit comprising an outer surface and an inner surface and whose light transmission, TL, of light of wavelength comprised between 380 and 780 nm, is altered between a minimum value, TLmin, and a maximum value, TLmax, upon variation of a voltage applied to the electrochromic glazing unit,
(b) A source of electrical power for varying the voltage applied to the electrochromic glazing unit,
(c) A sensor for measuring values of a parameter representative of the irradiance, Is, of the sun on the outer surface of the electrochromic glazing unit,
(d) A controller for controlling the voltage applied to the electrochromic glazing unit, said controller being configured for carrying out the following steps:
   (i) Determining values of the irradiance, Is, based on the values of the parameter measured by the sensor,
   (ii) Dividing a range comprised between a lowest boundary, Is1, and a highest boundary, Is(N+1), of the irradiance, Is, into N intervals, Ri=[Isi, Is(i+1)[, wherein the values of Is1, Is(N+1), and N are predefined, and wherein i=1 to N+1.
   (iii) For a value of the irradiance, Is, lower than or equal to the lowest boundary, Is1, a voltage yielding the maximum value, TLmax, of the transmission is applied (if Is≤Is1⇒TL⇒TLmax),
   (iv) For a value of the irradiance, Is, higher than or equal to the highest boundary, Is(N+1), a voltage yielding the minimum value, TLmin, of the transmission is applied (if Is≥Is(N+1)⇒TL=TLmin),
   (v) For a value of the irradiance, Is, comprised in an i^{th} interval, Ri=[Isi, Is(i+1)[, of the N intervals, R1 to RN, a voltage yielding a value, TL(Ri), of the light transmission is applied as a function of the value of i which is comprised within the range defined by Equation (1), as follows:

$$T L ( R i ) = A i \times ( TL min + ɛ ) \times {( \sqrt[N - 1]{\frac{T L max}{T L min + ɛ}} )}^{N - i} - A i \times ɛ \times \frac{i - 1}{N - 1} \qquad ( 1 )$$

Wherein ε is comprised between 0 and 1, Ai=1 when i=1 or N+1, and Ai is comprised between 0.8 and 1.2 for i=2 to N.

In a preferred embodiment, ε=0 for values of TLmin>1%, yielding Eq. (1a):

$$T L ( R i ) = Ai \times TL min \times {( \sqrt[N - 1]{\frac{T L max}{TL min}} )}^{N - i} \qquad ( 1 a )$$

and ε=1 for values of TLmin≤1% yielding Eq.(1b):

$$T L ( R i ) = A i \times ( TL min + 1 ) \times {( \sqrt[N - 1]{\frac{T L max}{TL min + 1}} )}^{N - i} - A i \times ɛ \times \frac{i - 1}{N - 1} \qquad ( 1 b )$$

In case of doubt, the values of the transmission, TL, of a glazing are as defined in Equations 1 to 3 for simple, double and triple glazing of § 5.2 of EN410 (2011). The parameter used in determining tint level can be the Direct Normal Irradiance (DNI), which is the amount of solar radiation received per unit area by a surface that is always held perpendicular to the rays that come in a straight line from the direction of the sun at its current position in the sky. Direct Normal Irradiation can be either measured by a sensor directly or derived from other sensor measurements.

The range comprised between the lowest boundary, Is1, and the highest boundary, Is(N+1), of the irradiance, Is, is divided into N intervals, which need not necessarily have a constant breadth. It is preferred, however, to divide the range in N intervals Ri=(Isi, Is(i+1)) of same breadth (Is(i+1)−Isi=const. ∀i), such that,

$$I {s}_{i} = I {s}_{1} + \frac{I {s}_{N} - I {s}_{1}}{N} \times ( i - 1 )$$

In a preferred embodiment, the controller is configured for carrying out the steps (i) to (v) for two or more switchable glass windows, preferably based on the values of the parameter representative of the irradiance (Is) measured by a single sensor. For example, the controller can be configured for determining the values of the irradiance parameter, Is, based on the values of the parameter measured by one or more sensors as a function of specifications of each of the two or more switchable windows, including a spatial position and/or an orientation of the outer surface of each of the two or more switchable windows. The occurrences of fixed obstacles hiding the sun from the outer surface of the electrochromic glazing unit as a function of time of day and year can be entered into the controller. The determination of the values of the irradiance parameter, Is, can take said occurrences into account for determining a value of the irradiation reaching a given EC glazing unit, based on the measurement of the parameter by the one or more sensors.

The controller can also be configured for determining the values of the irradiance parameter, Is, based on a set of historical values measured by one or more sensors over a given period of time, e.g., to level out the responses of the EC glass unit to periods of intermittent sharp changes in irradiance.

Some aspects of the present invention can also be extended to other types of controls, like manual or scheduled, to minimized transition effects of such controls as well.

In a particular alternative embodiment the N intervals defined here can also be used with other controllers where a limited number of accessible tint level are desired. These controllers include, but are not limited to, manual control done by the user using switches, keypad, connected applications, scheduled events or decentralized decision making where the control is performed by another equipment like the building management system (BMS), the HVAC controller or the lighting controller. In this case the Ri parameter from Equation 1 is not provided by a the value measured a sensor but rather by an input from the user, the desired level specified in the scheduled or an input for another building component (BMS, HVAC or lighting).

### BRIEF DESCRIPTION OF THE FIGURES

For a fuller understanding of the nature of the present invention, reference is made to the following detailed description taken in conjunction with the accompanying drawings in which:

FIG. 1: shows (a) the interaction of incident light with a glazing, and (b) transmission as a function of wavelength for three commercially available glasses, G1, G2, G3.

FIG. 2: shows an example of control of the transmission, TL, as a function of solar irradiation, Is, for different values of Ai.

FIG. 3: shows the influence of the value of N on the transmission, TL, as a function of solar irradiation, Is.

FIG. 4: shows the influence of the value of ε=0 or 1 in Eq.(1) on the transmission, TL, as a function of solar irradiation, Is, for low values of TLmin≤1%

FIG. 5: shows a sensor and processor controlling several windows of a building.

FIG. 6: shows a mapping of sun exposure of a window as a function of time of day and time of year.

### DETAILED DESCRIPTION OF THE INVENTION

The present invention concerns a switchable glass window whose light and energy transmission are altered when voltage is applied. A switchable glass window suitable for the present invention includes any such switchable glass window comprising an electrochromic (EC) glazing unit comprising an outer surface and an inner surface and whose light transmission, TL, of light of wavelength comprised between 380 and 780 nm, is altered between a minimum value, TLmin, and a maximum value, TLmax, upon variation of a voltage applied to the electrochromic glazing unit. To power EC glazing unit the switchable glass window must also be provided with a source of electrical power for varying the voltage applied to the electrochromic glazing unit. Several techniques are available to a person of ordinary skill in the art for determining a value of the transmission, TL, of a glazing and, any such technique can be used. Because, though the values measured with any such technique are normally all correlated to one another, they do not necessarily give the same values. In case of doubt, however, the values of the transmission, TL, of a glazing are herein measured as defined in Equations 1 to 3 for simple, double and triple glazing of § 5.2 of EN410 (2011). EN410 (2011) defines a single value of the transmission of a glazing over a range of wavelengths by averaging the transmission values at each “visible” wavelength (380 nm to 780 nm) weighted by the solar power and human eye sensitivity at said wavelength values.

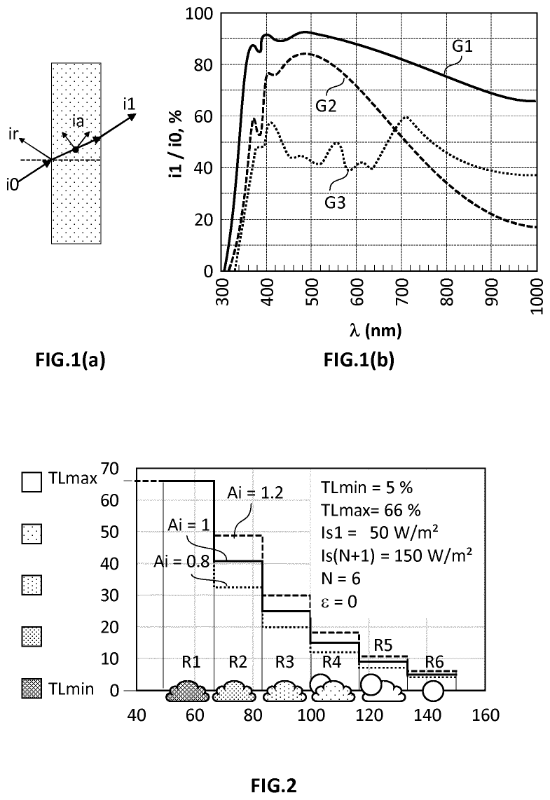

The variations of the transmission triggered by variations of a voltage applied to the electrochromic glazing unit according to the present invention can be achieved by any of a variation of the light absorption and/or the light reflection (cf. FIG. 1). The present invention is particularly suitable for switchable windows of large dimensions, such as architectural windows, having a diagonal of length of preferably at least 850 mm, preferably at least 1500 mm, more preferably at least 2500 mm.

### Irradiance, Is

As discussed in the review of the Background of the Invention, the transmission, TL, of such switchable glass windows can be controlled manually, e.g., with a remote control. The present invention concerns particularly automatically controlled switchable glass windows. For this reason, the switchable glass window of the present invention comprises also a sensor (5s) for measuring values of a parameter representative of the irradiance, Is, of the sun on the outer surface of the electrochromic glazing unit. Nevertheless, the N intervals in the sense of the present invention are equally useful to any other type of control, e.g. manual, scheduled, decentralized

The solar irradiance, Is, is herein defined as the power per unit area received on a surface from the sun in the form of electromagnetic radiation in the wavelength range of the measuring instrument. The solar irradiance integrated over time is called solar irradiation, insolation, or solar exposure. The parameter representative of the solar irradiance, Ir, measured by the sensor can for example be the Direct Normal Irradiance (DNI). The Direct Normal Irradiance is the amount of solar radiation received per unit area by a surface that is always held perpendicular to the rays that come in a straight line from the direction of the sun at its current position in the sky. Other parameters can be measured, but sensors measuring DNI, or that derive DNI from other sensor measured parameters, are commercially available off the shelves.

Based on the values of the parameter measured by the sensor, a controller (5c) is configured to determine values of the irradiance, Is. The controller must then adapt the value of the light transmission of the EC glazing unit to said values of the irradiance.

### Transmission as a Function of Irradiance

The gist of the present invention is the controller (5c) which is configured for automatically adapting the voltage applied to the electrochromic (EC) glazing unit to the instantaneous value of the solar irradiation, Is, the EC glazing unit is exposed to. The controller (5c) is so configured as to yield the following advantages:
(a) The fraction of time over the service life during which an EC-glazing unit is in a transition state can be reduced substantially, thus reducing the inconvenience of the iris or honeycomb effects, using state of the art EC-glazing units,
(b) The power consumption can be reduced and, last but not least,
(c) The automatic adaption of the light transmission of the EC glazing unit to a variation of the light irradiance is more comfortable to a human eye than state of the art automatic EC glazing units. This makes the use of the N intervals as defined here equally interesting for any other control method.

The foregoing advantages are provided by a controller (5c) according to the present invention configured for carrying out the following steps. Referring to FIG. 2, a range of the irradiance, Is, comprised between a lowest boundary, Is1, and a highest boundary, Is(N+1), is divided into N intervals, Ri=[Isi, Is(i+1)[, wherein the values of Is1, Is(N+1), and N are predefined, and wherein i=1 to N+1.

The boundary values of the transmission, TL, are defined as follows.

For a value of the irradiance, Is, lower than or equal to the lowest boundary, Is1, (e.g., a dim light) a voltage yielding the maximum value, TLmax, of the transmission is applied (if Is≤Is1⇒TL=TLmax). In other words, if the light is dim, the glazing is very ‘transparent’ (i.e., the transmission, i1/i0, of the EC glazing unit is maximized).
For a value of the irradiance, Is, higher than or equal to the highest boundary, Is(N+1), (e.g., a bright light), a voltage yielding the minimum value, TLmin, of the transmission is applied (if Is ≥Is(N+1) TL=TLmin), In other words, if the light is bright, the glazing lets little light through (i.e., the transmission, i1/i0, of the EC glazing unit is minimized).

For a value of the irradiance, Is, comprised in an i^{th} interval, Ri=[Isi, Is(i+1)[, of the N intervals, R1 to RN, a voltage yielding a value, TL(Ri), of the light transmission is applied as a function of the value of i which is comprised within the range defined by Equation (1), as follows:

$$T L ( R i ) = A i \times ( TL min + ɛ ) \times {( \sqrt[N - 1]{\frac{T L max}{T L min + ɛ}} )}^{N - i} - A i \times ɛ \times \frac{i - 1}{N - 1} \qquad ( 1 )$$

Wherein ε is comprised between 0 and 1, Ai=1 when i=1 or N+1, and Ai is comprised between 0.8 and 1.2 for i=2 to N.

The parameter ε in Equation (1) is particularly required for cases wherein TLmin→0. In a preferred embodiment, ε=0 for values of TLmin>1%, yielding Eq. (1a):

$$T L ( R i ) = Ai \times TL min \times {( \sqrt[N - 1]{\frac{T L max}{TL min}} )}^{N - i} \qquad ( 1 a )$$

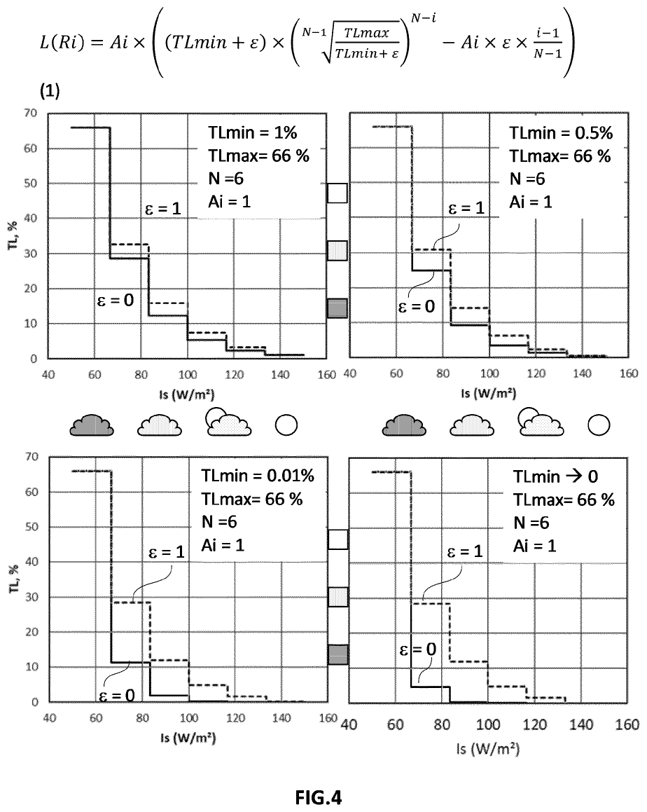

For values of TLmin≤1%, ε=1 yielding Eq.(1b):

$$T L ( R i ) = A i \times ( TL min + 1 ) \times {( \sqrt[N - 1]{\frac{T L max}{TL min + 1}} )}^{N - i} - A i \times ɛ \times \frac{i - 1}{N - 1} \qquad ( 1 b )$$

Wherein Ai, TLmin, TLmax, N, and i have the same meanings as defined with respect to Equation (1). FIG. 4(a)-(d) compare the transmission, TL, as a function of the irradiance, Is, for TLmin=1%, 0.5%, 0.01% and →0, in case of ε=0 (solid lines) and ε=1 (dashed lines). It can be seen that the variation of transmission between the first and second intervals (out of N=6 intervals) increases substantially when the value of TLmin tends towards 0. Setting the value of ε to 1 for values of TLmin≤1% allows maintenance of the profile of the curve TL=f(Is) obtained for larger values of TLmin. For values of TLmin>1%, the difference between ε=0 or 1 is negligible.

As defined supra, the range comprised between the lowest boundary, Is1, and the highest boundary, Is(N+1), of the irradiance, Is, must be divided into N intervals, Ri=(Isi, Is(i+1)). The division can be non-linear, e.g., with intervals of larger dimensions at small values of the irradiance. It is preferred, however, that the range be divided in N intervals of same magnitude, as follows,

$$I {s}_{i} = I {s}_{1} + \frac{I {s}_{N} - I {s}_{1}}{N} \times ( i - 1 )$$

### Advantages of the Present Invention

The variations of the transmission, TL, of the EC glazing unit as a function of the values of the irradiance, Ir, is represented graphically in FIG. 2, for values of Ai=0.8, 1, and 1.2, of ε=1, and of N=6 intervals R1 to R6. It can be seen that said relationship,
varies stepwise, with a constant value of the transmission, TL, over each range, Ri, and
the variations of the values of the transmission, TL, from one interval, Ri, to a next interval, R(i+1), does not vary linearly but following a power law.

A stepwise variation of the transmission, TL, is advantageous for (a) improving the comfort of the users, and (b) decreasing the power consumption. Indeed, a continuous response of the transmission of the EC glazing unit to variations in the light irradiance would keep the EC glazing unit in quasi-continuous transition mode, yielding quasi-continuously an iris or a honeycomb effect. Furthermore, since power is consumed only during the passage from one transmission state to another, the EC glazing unit would be consuming power continuously. By contrast, with a stepwise variation of the transmission, the EC glazing unit changes state only when a variation of given magnitude of the solar irradiation occurs, which corresponds to the magnitude of an interval, Ri, and an iris or honeycomb effect only occurs when an irradiation variation is larger than the amplitude of an interval, Ri. An operator can thus decide to tune the response sensitivity of the EC glazing unit to variations of light irradiance according to the requirements of a particular application.

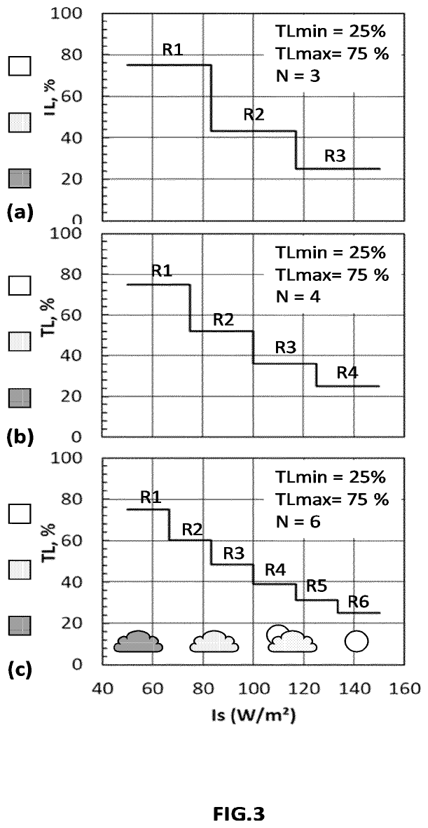

The effect of the number N of intervals on the response of the EC glazing units to variations of the light irradiation is illustrated in FIG. 3, with N=3 in FIG. 3(a), N=4 in FIG. 3(b), and N=6 in FIG. 3(c). The height of the steps decreases with increasing number, N, of steps, tending towards a smooth curve for very high values of the number N of steps. When the number N of intervals of a given range, [Is1, Is(N+1)] is very high, the magnitude of the intervals decreases and the behaviour tends towards a continuous reactivity of the EC glazing to light irradiation variations. This would be interesting e.g., when EC glazing units with very short transition periods are available, for windows of relatively lower dimensions, or for variations ranges [Is1, Is(N+1)] of small amplitude. Inversely, with a low number N of intervals, the amplitude of each interval, Ri, increases and the stepwise variation is more marked.

An exponential variation of the transmission from one interval, Ri, of irradiation to a next interval, R(i+1) is also advantageous for the comfort of the users. The relation between the actual change in a physical stimulus and the change perceived by a human user is non-linear. This applies to visual stimuli, of interest here, but also to other senses including hearing, taste, touch, and smell. For example, in the 19^{th} century, Fechner proposed that “Simple differential sensitivity is inversely proportional to the size of the components of the difference; relative differential sensitivity remains the same regardless of size.” This can be expressed in mathematical terms as, dP=kdS/S, wherein P is the perception, S a stimulus, and k a constant of correlation. In other words, an irradiance variation, ΔIs=Is(i+1)−Isi, of 5 W/m² absolute value is not perceived similarly by the human eye if the starting value of the irradiance, Isi, is low, e.g., Isi=10 W/m², or high, e.g., 50 W/m², because the relative variations dS/S of 5/10=50%, and 5/50=10%, respectively, are substantially different. To yield a similar perception starting from Isi=50 W/m² as from Isi=10 W/m², the variation should be of about 25 W/m², i.e., five times higher, to reach an irradiation value of 75 W/m² and yield a value of differential stimulus, dS/S=25/50=50% and thus trigger a similar perception as for an increase from 10 to 15 W/m².

In these conditions, it is clear that a linear response of the transmission to a variation of the irradiation cannot satisfy the comfort of a human user. Studies suggested that the eye senses brightness approximately logarithmically over a moderate range, but more like a power law over a wider range. The non-linear response of the transmission of the EC glazing unit to variations of the light irradiance defined by Equation (1) mimics the relationship between the perception of the human eye to a variation of a light stimulus. Thus, a variation of 5 W/m² from 10 to 15 W/m² triggers a larger decrease of transmission than a similar variation of 5 W/m² from 50 to 55 W/m². The comfort to the users is thus enhanced since the variations of transmission of the EC glazing unit follows the variations of perception by the human eye to variations of the light irradiance.

### Controller(s) & Sensor(s) Arrangements

In a preferred embodiment, a single controller (5c) can control more than one EC glazing unit and is configured for carrying out the steps (i) to (v) for two or more switchable glass windows. Each switchable window can be coupled to its own sensor (5s). This solution is interesting in that the sensor measures a parameter representative of the irradiance, Is, applied directly to the switchable window it is coupled to. The inconvenience is the cost and also the bulkiness of having to fit a sensor and wiring associated therewith to each and every window.

A preferred embodiment consists of coupling one sensor (5s) to two or more switchable glass windows. This is illustrated schematically in FIG. 5, wherein a single controller (5c) controls the transmission of all the switchable windows of a building based on the values of the parameter measured by a single sensor (5s). In this embodiment, the controller is configured for carrying out the steps (i) to (v) for two or more switchable glass windows based on the values of the parameter representative of the irradiance (Is) measured by a single sensor. The configuration illustrated in FIG. 5, however, has a problem in that the irradiance measured by a single sensor (5s) located e.g., on the roof of the building, cannot yield a single value of irradiance applicable to all the windows of the building, regardless of the orientation and height thereof. Two solutions can be applied independently or in combination: (1) coupling one sensor to a sub-group of switchable glass windows, e.g., one sensor for the windows facing South, one for the windows facing East, and so on, and (2) configuring the controller with an algorithm calculating the irradiance a given switchable window is exposed to on the basis of the values of the parameter measured by a sensor (5s) positioned at a different location and orientation from the given switchable window.

One sensor (5s) can be exposed to the sun and coupled to a number of switchable windows all sharing a same or similar exposition to the sun. In FIG. 5, this could include, for example, all the windows (LS,n, LS,n−1, . . . ) of the n^{th} and (n−1)^{th} (top) floors of the building on a wall exposed South (S), North (N), East (E), or West (W), which are on the right (R) and/or left (L) hand side of the wall. The sensor thus positioned measures a parameter directly representative of the irradiance received by the windows it is coupled to. This is a simple and efficient way of cutting costs by reducing the number of sensors without any additional issues to be solved.

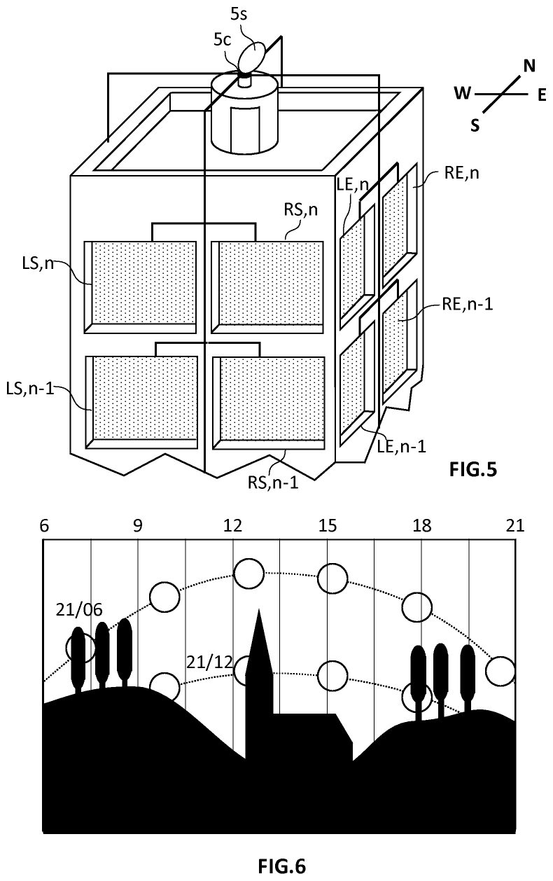

In a more sophisticated embodiment, the controller can control the transmission variations of several switchable windows having different orientations and exposures to light from one another, based on the measurements of the parameter by a single sensor (5s) having a different orientation than any of the windows it is coupled to. In this embodiment, the controller is configured for determining the values of the irradiance parameter, Is, based on the values of the parameter measured by one or more sensors (5s) as a function of specifications of each of the two or more switchable windows (LS,n, LE,n, . . . ), including a spatial position and/or an orientation of the outer surface of each of the two or more switchable windows. The controller can even be configured with an algorithm predicting the interference of physical obstacles between the position of the sun and the position of a given switchable window, as a function of the time of day and the date of year. FIG. 6 illustrates an example of landscape visible from a given switchable window. It can be seen that some days of the year, at certain hours of the day, physical obstacles, such as a building, trees, etc. cast their shadow onto the switchable window.

The controller may also be configured for determining the values of the irradiance parameter, Is, based on a set of historical values measured by one or more sensors. For example, in case of a sunny day with numerous clouds of small dimensions moving at high speed and hiding and showing the sun intermittently, the value of the irradiance would change intermittently between high and low values depending on whether the clouds hide or show the sun. In these conditions, the transmission, TL, of the EC glazing unit may change more often during a given time period than desirable. The controller can be configured for identifying such situations, and for setting the value of the transmission of the EC glazing unit to a comfort mode corresponding to the lowest value recorded in a last period of time (e.g., in the last hour). The switchable window in such comfort mode is a little darker than would be ideal, when the darkest clouds hide the sun, but gives an optimal perception when the sun is shining, while not shifting from one transmission value to another intermittently.

The present invention provides a substantial progress in the automatic control of the transmission of a switchable glass window as a function of irradiance. The controller (5c) is so configured as to ensure comfort to a human eye, on the one hand, by aligning the response of tint variation with the perception of the human eye to variations of a light stimulus and, on the other hand, by reducing the number of times an EC glazing unit goes through a transition state. The present invention also provides a substantial economy by reducing the number of transition states, which require power to drive an EC glazing unit from one state to another, and by allowing a reduction of the number of sensors and controllers required for controlling a set of several switchable glass windows.

| REF | FEATURE |
|---|---|
| 5c | controller |
| 5s | Light sensor |
| Ai | Fitting parameter in Eq.(1) |
| G1-3 | Commercial glasses 1, 2, and 3 |
| I0 | Incident light |
| I1 | Transmitted light |
| Ia | Absorbed light |
| ir | Reflected light |
| Is | (solar) irradiance |
| Isi | Value i of the solar irradiance Is, with I = 1 to (N +1) |
| LS, n, | Window on the left-hand side (L) of a south (S), east (E), |
| LE,n, . . . | etc. wall of a building, at an n^{th} floor |
| N | Number of intervals of Is between Is1 and Is(N + 1) |
| Ri | Interval i, with I = 1 to (N + 1) |
| RS, n, | Window on the right-hand side (R) of a south (S), |
| RE, n, . . . | east (E), etc. wall of a building, at an n^{th} floor |
| TL | Light transmission of a switchable glass window |
| TLi | Value of TL corresponding to a value Isi of the irradiance |
| TLmax | Maximal transmission obtainable by an EC glazing unit |
| TLmin | Minimal transmission obtainable by an EC glazing unit |
| ε | Correcting parameters for values of TLmin <1% |
| λ | wavelength |

1. Switchable glass window whose light and energy transmission are altered when voltage is applied comprising,
(a) An electrochromic (EC) glazing unit comprising an outer surface and an inner surface and whose light transmission, TL, of light of wavelength comprised between 380 and 780 nm, is altered between a minimum value, TLmin, and a maximum value, TLmax, upon variation of a voltage applied to the electrochromic glazing unit,
(b) A source of electrical power for varying the voltage applied to the electrochromic glazing unit,
(c) A sensor (5s) for measuring values of a parameter representative of the irradiance, Is, of the sun on the outer surface of the electrochromic glazing unit,
(d) A controller (5c) for controlling the voltage applied to the electrochromic glazing unit, said controller being configured for carrying out the following steps:
(i) Determining values of the irradiance, Is, based on the values of the parameter measured by the sensor,
(ii) Dividing a range comprised between a lowest boundary, Is1, and a highest boundary, Is(N+1), of the irradiance, Is, into N intervals, Ri=[Isi, Is(i+1)], wherein the values of Is1, Is(N+1), and N are predefined, and wherein i=1 to N+1.
(iii) For a value of the irradiance, Is, lower than or equal to the lowest boundary, Is1, a voltage yielding the maximum value, TLmax, of the transmission is applied (if Is≤Is1⇒TL=TLmax),
(iv) For a value of the irradiance, Is, higher than or equal to the highest boundary, Is(N+1), a voltage yielding the minimum value, TLmin, of the transmission is applied (if Is≥Is(N+1)⇒TL=TLmin),
(v) For a value of the irradiance, Is, comprised in an i^{th} interval, Ri=[Isi, Is(i+1)], of the N intervals, R to RN, a voltage yielding a value, TL(Ri), of the light transmission is applied as a function of the value of i which is comprised within the range defined by Equation (1), as follows:
$$T L ( R i ) = A i \times ( TL min + ɛ ) \times {( \sqrt[N - 1]{\frac{T L max}{T L min + ɛ}} )}^{N - i} - A i \times ɛ \times \frac{i - 1}{N - 1} \qquad ( 1 )$$
Wherein ε is comprised between 0 and 1, Ai=1 when i=1 or N+1, and Ai is comprised between 0.8 and 1.2 for i=2 to N.

2. Switchable glass window according to claim 1, wherein ε=0 for values of TLmin>1%, yielding Eq. (1a):
$$T L ( R i ) = Ai \times TL min \times {( \sqrt[N - 1]{\frac{T L max}{TL min}} )}^{N - i} \qquad ( 1 a )$$
and wherein ε=1 for values of TLmin≤1% yielding Eq. (1b):
$$T L ( R i ) = A i \times ( TL min + 1 ) \times {( \sqrt[N - 1]{\frac{T L max}{TL min + 1}} )}^{N - i} - A i \times ɛ \times \frac{i - 1}{N - 1} \qquad ( 1 b )$$

3. Switchable glass window according to claim 1, wherein the values of the transmission, TL, of a glazing are as defined in Equations 1 to 3 for simple, double and triple glazing of § 5.2 of EN410 (2011).

4. Switchable glass window according to claim 1, wherein the range comprised between the lowest boundary, Is1, and the highest boundary, Is(N+1), of the irradiance, Is, is divided into N intervals, Ri=(Isi, Is(i+1)), as follows,
$$I {s}_{i} = I {s}_{1} + \frac{I {s}_{N} - I {s}_{1}}{N} \times ( i - 1 )$$

5. Switchable glass window according to claim 1, wherein the parameter measured by the sensor is the Direct Normal Irradiance (DNI), which is measured normal to a surface of the sensor.

6. Switchable glass window according to claim 1, wherein the controller is configured for carrying out the steps (i) to (v) for two or more switchable glass windows.

7. Switchable glass window according to claim 5, wherein the controller is configured for carrying out the steps (i) to (v) for two or more switchable glass windows based on the values of the parameter representative of the irradiance (Is) measured by a single sensor.

8. Switchable glass window according to claim 6, wherein the controller is configured for determining the values of the irradiance parameter, Is, based on the values of the parameter measured by one or more sensors (5s) as a function of specifications of each of the two or more switchable windows (LS,n, LE,n, . . . ), including a spatial position and/or an orientation of the outer surface of each of the two or more switchable windows.

9. Switchable glass window according to claim 8, wherein the occurrences of fixed obstacles hiding the sun from the outer surface of the electrochromic glazing unit as a function of time of day and year are entered into the controller, and wherein the determination of the values of the irradiance parameter, Is, takes said occurrences into account for determining a value of the irradiation reaching a given EC glazing unit, based on the measurement of the parameter by the one or more sensors.

10. Switchable glass window according to claim 1, wherein the controller is configured for determining the values of the irradiance parameter, Is, based on a set of historical values measured by one or more sensors.

11. Switchable glass window according to claim 1, wherein the variation of a voltage applied to the electrochromic glazing unit alters the light and energy transmission, TL, by varying the light absorption and/or the light reflection.
